(19) United States
(12) Patent Application Publication
(10) Pub. No.: US 2010/0153677 A1
(43) Pub. Date: Jun. 17, 2010

(54) METHOD FOR STATICALLY ALLOCATING STACK BASED ON MULTI THREAD

(75) Inventors: Sangcheol KIM, Gyeongbuk (KR); Haeyong Kim, Daejeon-city (KR); Pyeongsoo Mah, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/609,164

(22) Filed: Oct. 30, 2009

(30) Foreign Application Priority Data
Dec. 11, 2008 (KR) 10-2008-0125669

(51) Int. Cl. G06F 12/02; G06F 12/00

(52) U.S. Cl. 711/170; 711/E12.001; 711/E12.002

(57) ABSTRACT

Provided is a method for statically allocating a stack based on multi thread. The method includes arbitrarily dividing a heap area and a stack area; allocating a stack space of each thread to the heap area at a predetermined size before executing the thread; swapping the stack of each thread in a stack area and measuring a stack size during executing the corresponding thread; and varying the heap area according to the measured stack size and reallocating the stack space of each thread allocated to the heap area. The provided executes programs without analyzing a complicated source code to expect the proper stack size of the thread while effectively using the stack memory during execution time as maximally as possible and statically allocates a stack memory based on the used amount of the measured stack to remove an overhead that moves the stack.

### RELATED APPLICATIONS

The present application claims priority to Korean Patent Application Serial Number 10-2008-0125669, filed on Dec. 11, 2008, the entirety of which is hereby incorporated by reference.

### BACKGROUND OF THE INVENTION

1. Field of the Invention

The present invention relates to a method for statically allocating a stack based on a multi thread, and in particular, to a method for statically allocating a stack based on a multi thread capable of effectively allocating a thread stack when using an operating system based on a multi thread in an embedded system for a wireless sensor node without MMU.

2. Description of the Related Art

In general, a wireless sensor network is a wireless network that senses various environmental information, processes the information into the user desired form, and communicates it in real time. The wireless sensor network is configured of several hundred or thousand wireless sensor nodes, wherein each sensor node performs a function that communicates with adjacent nodes, collects the environmental information, processes the collected information, and transmits it to the user in real time.

At this time, the sensor node should be configured of a very small size in consideration of costs, such that the cost efficiency of the entire network can be achieved. As a result, the sensor node includes a small memory of about 2 KB to 10 KB. Further, the sensor node does not have a memory hardware protective device, that is, a memory management unit (MMU) due to low power and low cost.

Even the embedded system having a limited memory needs a multi thread based operating system to perform several tasks in parallel. The multi thread based operating system should allocate a unique stack to a memory space for each thread. The method for allocating a static thread stack according to the related art allocates the stack space to be used by the corresponding thread at a static size upon generating a thread.

However, since an application program can be in various forms, it is very difficult to expect how each thread uses the stack prior to executing the application program. Therefore, in the case where the static stack allocating method for arbitrarily allocating the stack size is used at the time of starting the application program, the stack size is too largely allocated such that there is a risk of causing unnecessary waste of the thread stack memory. On the other hand, when the stack having a too small size is allocated in a sensor node platform having a limited memory without the MMU, a serious problem occurs such as a stack overflow occurs.

In order to solve the above problems, the stack space of each thread is allocated to the memory by using a method for expecting the used amount of the thread stack depending on the source code analysis, a method for dynamically adjusting the allocated stack size, etc. However, there are problems in that the source code analysis is very complicated and difficult and consumes a lot of time. In addition, there are problems in that the method for dynamically adjusting the allocated stack size due to a complicated algorithm and a large overhead when the memory needs to be copied.

### SUMMARY OF THE INVENTION

It is an object of the present invention to provide a method for statically allocating a stack based on a multi thread capable of effectively using a memory space when supporting the multi thread in a space restrictive sensor node operating system without a memory management unit (MMU).

It is another object of the present invention to provide a method for allocating a stack based on a multi thread having very simple algorithm so that it can be rapidly implemented without analyzing a complicated source code.

It is yet another object of the present invention to provide a method for allocating a stack based on a multi thread capable of measuring the used amount of the stack during the execution of the thread and statically allocating a stack memory based on the used amount of the measured stack not to cause a stack overhead.

In order to achieve the above object, there is provided a method for statically allocating a stack based on a multi thread, including: arbitrarily dividing a heap area and a stack area; allocating a stack space of each thread to the heap area with a predetermined size before executing the thread; swapping the stack of each thread in a stack area and measuring a stack size while executing the corresponding thread; and varying the heap area according to the measured stack size in the measuring the size of the stack and reallocating the stack space of each thread to the heap area.

In addition, the method for statically allocating a stack further includes forming a plurality of bands in the stack area at a predetermined interval prior to the measuring the stack size. The band is formed by a bit number of a stack variable owned by the stack of the corresponding thread. At this time, each bit of the stack variable corresponds to each of the plurality of bands formed in the stack area and has a value of ‘0’ or ‘1’.

The band formed in the stack area is a memory area having a predetermined value and has a positive integer value that represent a predetermined unit size in a direction from bottom to top of the stack area.

In the measuring the stack size, the corresponding stack is allocated to the stack area so as to be overlapped with the bands by the corresponding stack size during the execution of each thread in a direction from bottom to top of the stack area. At this time, each bit value of the stack variable owned by the stack that is allocated to the stack area is initialized to ‘0’ and when the stack of the executing thread is overlapped with the bands, the bit value of the stack variable corresponding to the corresponding band is converted into ‘1’. Moreover, when the stack of the executing thread is overlapped with the band, the value of the corresponding band is converted.

The measuring the stack size measures the corresponding stack size according to the change in the value of the band formed in the stack area during the execution of each thread.

Meanwhile, the measuring the stack size further includes recording the measured stack size in the stack variable owned by the corresponding stack during the execution of each thread. The reallocating reallocates the stack space of the corresponding thread based on the stack size recorded in the stack variable.

In addition, the stack area varies according to the heap area of the reallocating.

The present invention executes programs without analyzing the complicated source code in determining the stack size of the thread, making it possible to expect the proper stack size of the thread while effectively using the stack memory as much as possible during the execution of the thread. In addition, the method for allocating a stack of the present invention does not need to analyze the complicated source code, such that it can be very simply and rapidly operated.

Further, since the stack memory is statically allocated based on the used amount of the measured stack during the execution of the thread, the present invention can solve the problem of an unnecessary waste caused by largely allocating the stack memory or the occurrence of stack overflow caused by less allocating the stack memory. Moreover, the present invention statically allocates the stack memory, making it possible to prevent the occurrence of the overhead due to the copy of the stack memory.

### BRIEF DESCRIPTION OF THE DRAWINGS

FIG. 1 is a flowchart showing an operational flow of a stack allocating method based on a multi thread according to the present invention;

FIG. 2 is a flowchart showing a detailed operational flow of FIG. 1;

FIGS. 3A and 3B are exemplary diagrams showing a stack space allocated to a memory area according to the present invention;

FIGS. 4A to 6C are exemplary diagrams referenced for explaining an operation of a method for measuring a stack size according to the present invention; and

FIGS. 7A and 7B are exemplary diagrams referenced for explaining an operation of a method for statically allocating a stack space to a memory area according to a stack size according to the present invention.

### DETAILED DESCRIPTION OF THE PREFERRED EMBODIMENTS

Hereinafter, exemplary embodiments of the present invention will be described with reference to the accompanying drawings.

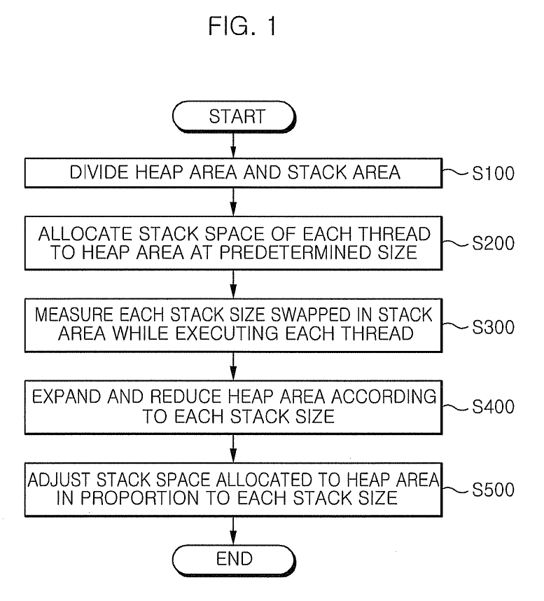

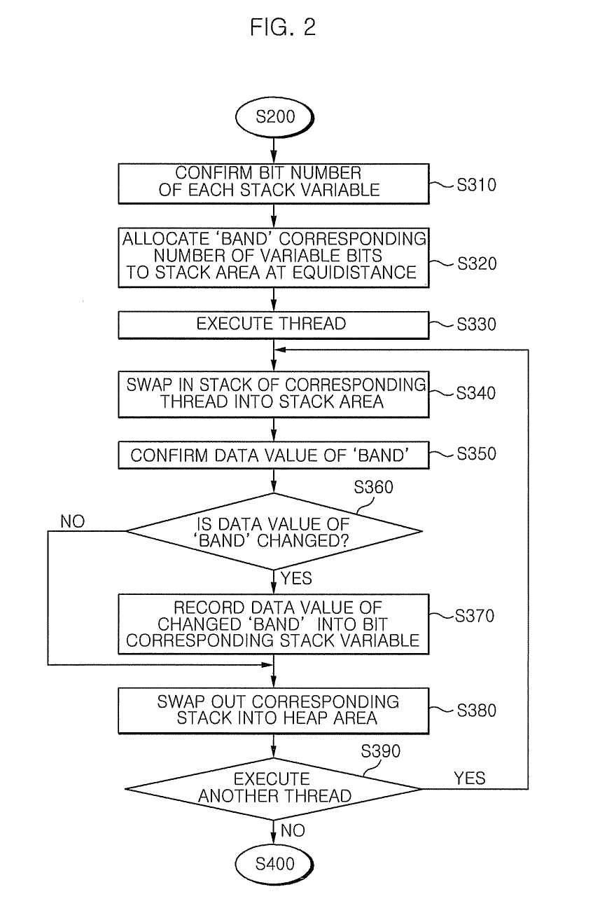

FIGS. 1 and 2 are flowcharts showing an operational flow of a method for statically allocating a stack based on a multi thread according to the present invention.

As shown in FIG. 1, the method for statically allocating a stack according to the present invention first divides a memory area into a heap area and a stack area (S100).

The heap area is an area in which a stack space of a thread is allocated. Further, the stack area is an area that can commonly use the stack memory during the execution of each thread that is allocated to the heap area. For convenience, it is assumed that the heap area is increased from a lower address to a higher address and the stack address is increased from a higher address to a lower address. At this time, the size of the heap area and the stack area is arbitrarily divided and not fixed to the initially divided area but if the memory usage of the heap area is small according to the stack size of each thread, the stack area becomes relatively large and if the memory usage of the heap area is large, the stack area becomes relatively small.

Herein, a thread means an execution unit within one program. For example, each task is represented by a thread in JAVA and the thread can be arranged in plural such that multi-tasking can be achieved.

If the memory area is divided into the heap area and the stack area, the stack space of the thread is allocated to the heap area among the divided memory area (S200). At this time, each of the stack spaces is allocated to the heap area at a predetermined size and has a minimum size. For example, when the minimum size of each stack is 128 bytes, each stack space is allocated to the heap area to have 128 bytes.

During the execution of each thread, the stack of each thread allocated to the heap area is swapped in the stack area. At this time, the corresponding stack size copied into the stack area is measured upon executing each thread (S300). At this time, step ‘S300’ should be performed with a sufficient time so that the stack size can be measured. Herein, an operational flow of step ‘S300’ will be described in detail with reference to FIG. 2.

If the measurement time of the stack size sufficiently elapses, the heap area is expanded or reduced according to the measured stack size during the execution of each thread (S400). At this time, each stack space allocated to the heap area at step ‘S200’ is adjusted in proportion to each stack size measured at step ‘S300’. At this time, the stack area also varies according to the varying size of the heap area.

FIG. 2 shows in detail an operational flow of step ‘S300’ of FIG. 1.

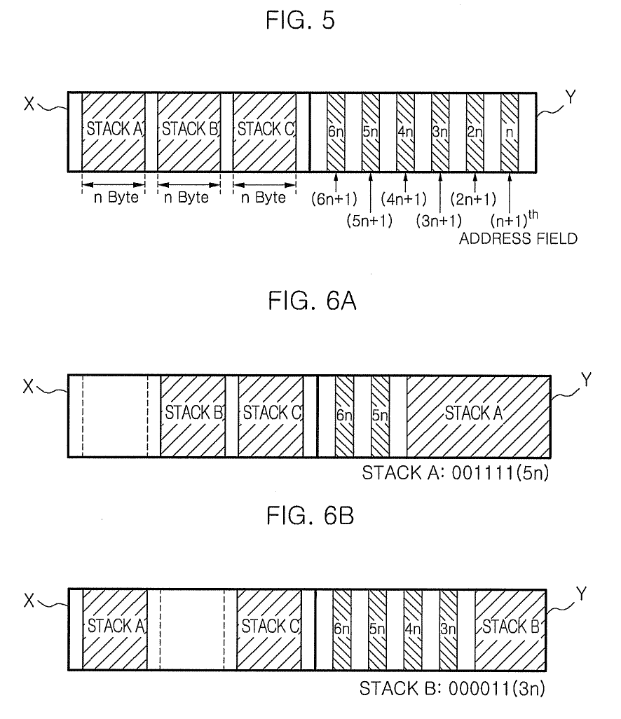

Referring to FIG. 2, before executing each thread, bit numbers and bit values of stack variables owned by each stack are confirmed (S310). In other words, it is confirmed that the bit values of each stack variable is ‘0’ or ‘1’. If the bit numbers and bit values of each stack variable are confirmed, a plurality of bands are formed in the stack area, corresponding to the bit numbers and bit values of the confirmed variables (S320). Herein, the band formed in the stack area is a memory area having a predetermined value and has a positive integer value showing a predetermined unit size. Thereafter, the stack size is measured from values owned by each band. At this time, each of the plurality of bands is formed at equidistance. As one example, the bands are formed at positions of n+1, 2n+1, 3n+1, . . . , 8n+1, respectively, in a top direction of the stack area. Therefore, each band is formed in the stack area at an n byte interval. n represents a data size in a byte unit. At this time, each band has values of n, 2n, 3n, . . . , 8n. In other words, if the used amount of the actual stack is n bytes, the band having the value of n is formed at a position of n+1, such that the stack size can be measured from the value of the corresponding band. The detailed embodiment thereof will be described with reference to FIG. 5. The bit values of the stack variables are initialized ‘0’ to record the stack size measured later.

Meanwhile, each band is formed to correspond to each bit of variables confirmed in step ‘S310’. For example, if the bit of the variable confirmed at step ‘S310’ is ‘00000111’, the band is formed at the remaining ‘4n+1’, ‘5n+1’, . . . , ‘8n+1’-th fields other than ‘n+1’, ‘2n+1’, and ‘3n+1’-th fields that are a position where the bit value corresponds to ‘1’. If all the bit values of the confirmed variables are ‘0’, the bands are formed at ‘n+1’, ‘2n+1’, ‘3n+1’, . . . , ‘8n+1’-th fields, respectively, as described above.

If the band is formed at the stack area, then each thread should be executed (S330).

During the execution of each thread, the stack allocated to the heap area is swapped in the stack area. In other words, if one thread is selected, the stack of the corresponding thread is copied, which is in turn swapped in the stack area (S340). At this time, the stack is allocated to be overlapped with the band by the corresponding stack size in a direction from bottom to top of the stack area, the band being formed in the stack area. If the stack of the executing thread is overlapped with the band formed in the stack area, the bit value of the stack variable corresponding to the corresponding band is set to ‘1’.

Further, the stack size is measured during the execution of the corresponding thread (S350 to S370). At this time, the stack size is measured according to the change in the bit value of the stack variable corresponding to each band. For example, if the bit value of the initial stack variable is ‘00000000’ and the bit value of the stack variable is changed to ‘00001111’ by the stack of the executing thread, values of four bands are changed by the stack, such that the stack size becomes 5n. At this time, the value of the band having the smallest one of the values that the bit values of the stack variables corresponding to each band are ‘0’ becomes the stack size.

If the measurement of the corresponding stack size is completed, the measured stack size is recorded in the stack variable and the stack of the stack area is swapped out to the heap area again (S380). Finally, the value recorded in the stack variable is maintained before the stack space is statically allocated to the heap area. Meanwhile, if the stack of the stack area is swapped out, steps ‘S340’ to ‘S380’ are repetitively performed by swapping the stacks of other threads in the stack area, such that the stack sizes of all the threads are measured.

If the measurement of the stack sizes of all the threads complete, steps after step ‘s400’ of FIG. 1 are performed, such that the stack space of each thread is statically allocated to the memory area.

Therefore, the method for statically allocating a stack on based a multi thread according to the present invention executes programs without analyzing a complicated source code to expect the proper stack size of the thread while effectively using the stack memory as much as possible during execution time and statically allocates a stack memory based on the used amount of the measured stack to remove overhead that moves the stack.

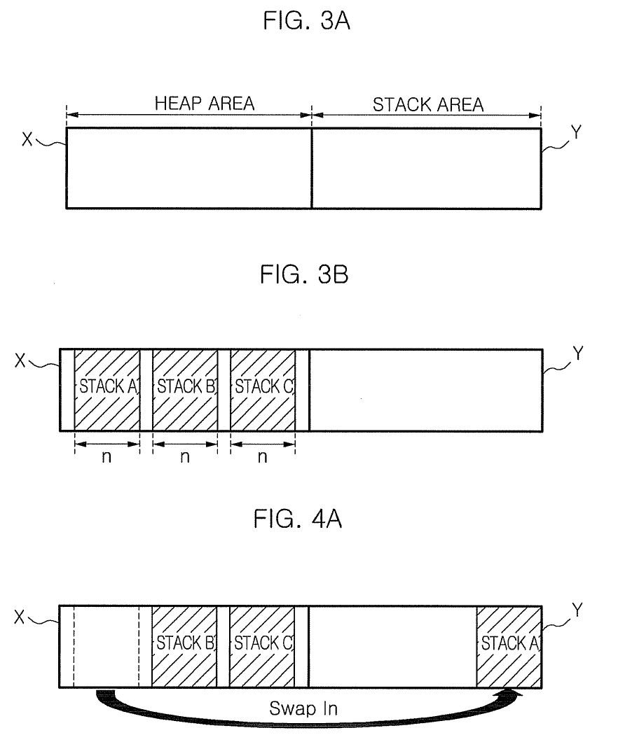

Hereinafter, referring to FIGS. 3 to 7B, the detailed embodiment of FIGS. 1 and 2 will be described.

First, FIGS. 3A and 3B show an initial process that allocates the stack spaces of each thread to the memory area. In other words, as shown in FIG. 3A, the memory area is divided into the heap area X and the stack area Y. At this time, the size of the divided heap area X and the stack area Y is not fixed and is varied according to the stack size.

FIG. 3B is an exemplary diagram showing an operation of allocating the stack spaces of each thread in the heap area. If the executing thread is thread A, thread B, and thread C, it is assumed that all the threads have their own stacks, that is, stack A, stack B, and stack C. At this time, the spaces of the stack A, stack B, and stack C are allocated to the heap area X. Herein, the spaces of the stack A, stack B, and stack C are allocated at a predetermined space and are allocated at a minimum size (n byte) that can be owned by the stacks.

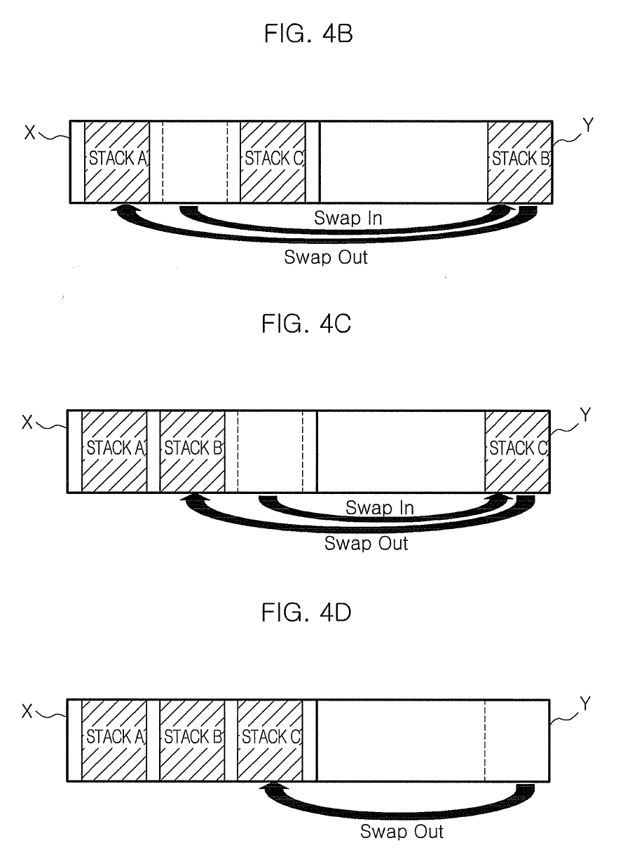

FIGS. 4A to 4D are exemplary diagrams showing an operation when the stack A, stack B, and stack C allocated to the heap area X are swapped in the stack area during the execution of thread A, thread B, and thread C.

First, as shown in FIG. 4A, the stack A is swapped in the stack area Y to execute thread A. The size of the stack A is measured during the execution of the stack A and the measured value is recorded in variable of the stack A.

Meanwhile, as shown in FIG. 4B, if the measurement of the size of the stack A is completed, the stack A of the stack area Y is swapped out to the heap area X and at the same time, the stack B of the subsequently executing thread B is swapped in the stack area Y. Likewise, the size of the stack B that is swapped in the stack area Y during the execution of the thread B is measured and the measured value is recorded in the size variable of the stack B.

Meanwhile, as shown in FIG. 4C, if the measurement of the size of stack B is completed, the stack B of the stack area Y is swapped out to the heap area X again and at the same time, the stack C of the subsequently executing thread C is swapped in the stack area Y. Likewise, the size of the stack C that is swapped in the stack area Y during the execution of the thread C is measured and the measured value is recorded in the size variable of the stack C. Thereafter, as shown in FIG. 4D, the stack C of the stack area Y is swapped out to the heap area X again.

Since the stack area Y is used for sharing all the threads, the usable stack area Y is larger than a case where it does not share the stack, such that the thread has little limitation in using the stack space due to the use of the foregoing algorithm, thereby remarkably reducing the risk of stack overflow.

The embodiment of FIGS. 4A to 4D describe, by way of example, a case where thread A, thread B, and thread C are sequentially executed for convenience sake but is not limited thereto. As a result, thread B, thread A, and thread C or thread C, thread A, and thread B, etc. can be implemented differently according to the setting.

FIGS. 5 to 6C are exemplary diagrams referenced for describing an operation of measuring the stack size.

First, FIG. 5 is an embodiment that forms the band in the stack area before the execution of the thread. In other words, before the stack stored in the heap area X moves to the stack area Y in order to execute the thread, the variable bit of the corresponding stack is investigated. At this time, it is determined whether the variable bit of the corresponding stack has any value of ‘0’ and ‘1’, such that the band is formed at a predetermined size interval in the stack area Y.

FIG. 5 shows the data value of the band that is formed in the stack area. At this time, the band is formed at an n byte interval that is the minimum size of the stack, such that the band is formed in the field whose addresses are ‘n+1’, ‘2n+1’, ‘3n+1’, . . . , ‘6n+1’. Therefore, the bands such as n, 2n, 3n, . . . , 6n are formed in the stack area Y at n byte intervals. The reason is that if the used amount of the actual stack is n bytes, the band having the value of n is formed at a position of n+1, such that the stack size can be measured from the value of the corresponding band. Herein, the interval of each band is not fixed but can be arbitrarily changed. Each band is maintained at equidistance.

FIGS. 6A to 6C are exemplary diagrams showing an operation of measuring each size of stack A, stack B, and stack C, respectively. FIG. 6A shows an operation of measuring the size of stack A. If the stack A is swapped in the stack area Y, the bit value of the stack variable corresponding to the band overlapped with the stack A is changed from ‘0’ to ‘1’ according to the change in the size of the stack A during the execution of the thread A.

In FIG. 6A, the bit value of the stack variable corresponding to the corresponding band is ‘1’ in the state where the stack A is overlapped with the band having the data value of n, 2n, 3n, and 4n. Therefore, the value of the stack variable of the stack A is ‘001111’ and the used amount of the stack during the execution of the thread A becomes ‘5n’ having a small value of the bands that does not overlap the swapped-in stack A. In other words, the data value ‘5n’ of the band having a small value of the bands (5n, 6n) corresponding to the stack variable whose bit value is ‘0’ becomes the stack size.

As such, if the size of stack A is measured, the measured size of stack A is recorded in the stack variable. Thereafter, if the stack A is swapped out to the heap area X, all the data values of each band formed in the stack area Y are initialized to ‘n’, ‘2n’, ‘3n’, . . . , ‘6n’ in order to measure the size of other stacks.

Meanwhile, FIG. 6B shows an operation of measuring the size of stack A. If the stack B is swapped in the stack area Y, the bit value of the stack variable corresponding to the band overlapped with the stack B is changed from ‘0’ to ‘1’ according to the change in the size of stack B during the execution of the thread B. In FIG. 6B, the bit value of the stack variable corresponding to the corresponding band becomes ‘1’ in the state where the stack B is overlapped with n and 2n. Therefore, the value of the stack variable of the stack B is ‘000011’ and the used amount of the stack during the execution of the thread B becomes ‘3n’ having a small value of the bands that does not overlap the swapped-in stack B. As such, if the size of stack B is measured, the measured size of stack B is recorded in the stack variable. Likewise, if the stack B is swapped out to the heap area X, the data values of each band formed in the stack area Y are initialized to ‘n’, ‘2n’, ‘3n’, . . . , ‘6n’ in order to measure the size of other stacks.

In addition, FIG. 6C shows an operation of measuring the size of stack C. If the stack C is swapped in the stack area Y, the bit value of the stack variable corresponding to the band overlapped with the stack C is changed from ‘0’ to ‘1’ according to the change in the size of the stack C during the execution of the thread C. In FIG. 6A, the bit value of the stack variable corresponding to the corresponding band becomes ‘1’ in the state where the stack C is overlapped with n, 2n, and 3n. Therefore, the value of the stack variable of the stack C is ‘000111’ and the used amount of the stack during the execution of the thread C becomes ‘4n’ having a small value of the bands that does not overlap the swapped-in stack C. As such, if the size of stack C is measured, the measured size of stack C size is recorded in the stack variable. Likewise, if the stack C is swapped out to the heap area X, the data values of each band formed in the stack area Y are initialized to ‘n’, ‘2n’, ‘3n’, . . . , ‘6n’ in order to measure the sizes of other stacks.

At this time, a process of confirming the data values of each band is performed by a maximum bit number of variables owned by each thread. In other words, when the maximum bit number of variables owned by the thread is 6, the data values of bands from n to 6n are confirmed as shown in FIGS. 5 to 6C. Of course, in a process of initially generating the band, the band can be formed by the maximum bit number of variables owned by the corresponding thread but can be formed by the number exceeding the above bit number as an extra.

Herein, the method for measuring the stack amount can be easily obtained by scanning the bits from the measured variable value (counting until the value of 0 comes out by performing a right shift). As described above, there is an advantage in that the method for expecting a proper stack size of a thread using the band does not generate overhead.

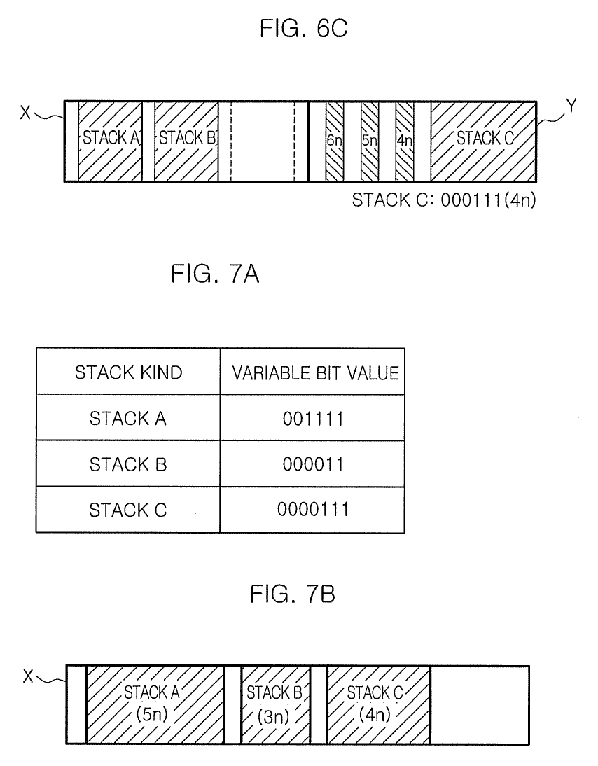

FIGS. 7A and 7B are exemplary diagrams referenced for explaining an operation of a method for statically allocating the stack space to the memory area according to a stack size according to the present invention.

First, FIG. 7A is an exemplary diagram showing the stack size measured in the process of swapping each stack in the stack area. In other words, as described in the embodiment of FIG. 6, the stack size is recorded in the stack variables owned by the stacks of each thread. At this time, the bit value of ‘001111’ is recorded in the stack variable of the stack A and the bit value of ‘000011’ is recorded in the stack variable of the stack B. Further, the bit value of ‘000111’ is recorded in the stack variable of the stack C. At this time, the used amount of the stack during the execution of thread A, thread B, and thread C is 5n, 3n, and 4n, respectively.

Therefore, if the measurement time of the stack sufficiently elapses, referring to the stack size of FIG. 7A, the stack is statically allocated using the variable value recorded in the stack variable owned by the stacks of each thread as shown in FIG. 7B.

In other words, as shown in FIG. 3B, the size of the stack space that is initially allocated to the heap area X is n byte, which is the minimum byte. At this time, the stack space initially allocated according to the stack size measured during the execution of each thread is reallocated.

Herein, the size of the heap area X varies according to the stack size and when the stack size is large, the stack area Y can be relatively reduced or removed according to the expansion of the heap area X. At this time, since the stack space of each thread is statically allocated, even though the stack area Y is removed, it has no effect on the execution of the thread. In addition, upon executing the thread, the overhead due to the stack movement disappears. In this case, since the necessary stack size is measured by executing the actual program, the complicated algorithm or the source code analysis is not needed.

The method for statically allocating a stack based on a thread according to the present invention as described above are not limited to the configuration and method of the embodiments as described above, but the embodiments may be configured by selectively combining all the embodiments or some of the embodiments so that various modifications can be made.

What is claimed is:

1. A method for statically allocating a stack based on a multi thread, comprising:
dividing a heap area and a stack area;
allocating a stack space of each thread to the heap area at a predetermined size before executing the thread;
swapping the stack of each thread in a stack area and measuring a stack size while executing the corresponding thread; and
varying the heap area according to the measured stack size in the measuring the stack size and reallocating the stack space of each thread.

2. The method for statically allocating a stack based on a multi thread according to claim 1, further comprising forming a plurality of bands in the stack area at a predetermined interval prior to the measuring the stack size.

3. The method for statically allocating a stack based on a multi thread according to claim 2, wherein the bands are formed by a bit number of a stack variable owned by the stack of the corresponding thread.

4. The method for statically allocating a stack based on a multi thread according to claim 3, wherein each bit of the stack variable corresponds to each of the plurality of bands formed in the stack area and has a value of ‘0’ or ‘1’.

5. The method for statically allocating a stack based on a multi thread according to claim 2, wherein the band formed in the stack area is a memory area having a predetermined value.

6. The method for statically allocating a stack based on a multi thread according to claim 2, wherein the band formed in the stack area has a positive integer value that represents a predetermined unit size in a direction from bottom to top of the stack area.

7. The method for statically allocating a stack based on a multi thread according to claim 2, wherein in the measuring the stack size, the corresponding stack is allocated to the stack area to be overlapped with the bands by the corresponding stack size during the execution of each thread in a direction from bottom to top of the stack area.

8. The method for statically allocating a stack based on a multi thread according to claim 7, wherein each bit value of the stack variable owned by the stack that is allocated to the stack area is initialized to ‘0’; and
when the stack of the executing thread is overlapped with the bands, the bit value of the stack variable corresponding to the corresponding band is converted into ‘1’.

9. The method for statically allocating a stack based on multi thread according to claim 7, wherein when the stack of the executing thread is overlapped with the band, the value of the corresponding band is converted.

10. The method for statically allocating a stack based on a multi thread according to claim 2, wherein the measuring the stack size measures the corresponding stack size according to the change in the value of the band formed in the stack area during the execution of each thread.

11. The method for statically allocating a stack based on a multi thread according to claim 1, wherein the measuring the stack size measures the bit value in the stack variable owned by the corresponding stack during the execution of each thread.

12. The method for statically allocating a stack based on a multi thread according to claim 1, wherein the measuring the stack size measures the used amount of the stack during the execution of each thread.

13. The method for statically allocating a stack based on a multi thread according to claim 1, wherein the measuring the stack size includes recording the measured stack size in the stack variable owned by the corresponding stack during the execution of each thread.

14. The method for statically allocating a stack based on a multi thread according to claim 13, wherein the reallocating reallocates the stack space of the corresponding thread based on the stack size recorded in the stack variable.

15. The method for statically allocating a stack based on a multi thread according to claim 1, wherein the stack area varies according to the heap area of the reallocating.
